(19) United States
(12) Patent Application Publication
(10) Pub. No.: US 2013/0313475 A1
(43) Pub. Date: Nov. 28, 2013

(54) APPARATUS AND PROCESS FOR PURIFICATION OF A NITROSAMINE-CONTAMINATED PRODUCT FROM AN OPERATING PLANT

(71) Applicants: Björn Fischer, Frankfurt a.M. (DE); Erwin Johannes Martinus Giling, AS Delft (NL); Earl Lawrence Vincent Goetheer, Mol (BE); Ralph Joh, Seligenstadt (DE); Rüdiger Schneider, Eppstein (DE); Jan Harm Urbanus, EW Loenen aan de Vecht (NL)

(72) Inventors: Björn Fischer, Frankfurt a.M. (DE); Erwin Johannes Martinus Giling, AS Delft (NL); Earl Lawrence Vincent Goetheer, Mol (BE); Ralph Joh, Seligenstadt (DE); Rüdiger Schneider, Eppstein (DE); Jan Harm Urbanus, EW Loenen aan de Vecht (NL)

(73) Assignee: SIEMENS AKTIENGESELLSCHAFT, Muenchen (DE)

(21) Appl. No.: 13/982,825

(22) PCT Filed: Jan. 17, 2012
(86) PCT No.: PCT/EP2012/050593

§ 371 Date: Jul. 31, 2013

(30) Foreign Application Priority Data
Jan. 31, 2011 (EP) 11152679.4

(51) Int. Cl. B01D 53/96

(52) U.S. Cl. CPC B01D 53/96
USPC 252/190; 422/187

(57) ABSTRACT

A process for purifying a product contaminated with nitrosamines from an operating plant is proposed. The contaminated product is heated to a temperature T at which the nitrosamines are thermally destroyed. The temperature T is set at a higher level than the maximum temperature in the operating plant, and maintained for a residence time t. An apparatus for regeneration of a nitrosamine-contaminated product from a CO₂ capture plant is also proposed.

### CROSS REFERENCE TO RELATED APPLICATIONS

This application is the US National Stage of International Application No. PCT/EP2012/050593 filed Jan. 17, 2012 and claims benefit thereof, the entire content of which is hereby incorporated herein by reference. The International Application claims priority to the European application No. 11152679.4 EP filed Jan. 31, 2011, the entire contents of which is hereby incorporated herein by reference.

### BACKGROUND OF INVENTION

In fossil-fired power plants for generation of electrical energy, the combustion of a fossil fuel gives rise to a carbon dioxide-containing flue gas. To avoid or to reduce carbon dioxide emissions, carbon dioxide has to be removed from the flue gases. In general terms, various methods are known for removal of carbon dioxide from a gas mixture. The method of absorption-desorption is commonly used especially for removal of carbon dioxide from a flue gas after a combustion operation. On the industrial scale, carbon dioxide is scrubbed out of the flue gas with a solvent (CO₂ capture operation).

Commonly used chemical solvents, for example methanolamine (MEA), exhibit a good selectivity and a high capacity for carbon dioxide (CO₂). Amine-based solvents, however, also irreversibly bind acidic secondary flue gas components (heat-stable salts) and further degradation products such as sulfur dioxide SO₂ or sulfur trioxide SO₃ in the form of sulfite and sulfate, and thus increasingly impair the efficacy of the solvent over the course of the operation. In order to counter this problem, in the case of solvents based on amino acids, there is the possibility of processing by distillation. This involves heating the solvent, such that the volatile amines are vaporized and recovered by condensation and thus removed from the high-boiling impurities.

A much more serious problem arises in the CO₂ capture operation as a result of the combination of amines with nitrogen oxides NOₓ. Even though the concentration of nitrogen oxides NOₓ in the flue gas is comparatively low, amines form nitrosamines, which are carcinogenic to organisms, with nitrogen oxides NOₓ directly or via side reactions. These nitrosamines have a very low vapor pressure, and they are therefore also discharged into the atmosphere via the flue gas.

There is high public awareness of nitrosamines, since they can occur in foods (especially in the case of improper preparation), and the majority are considered to be carcinogenic. Therefore, nitrosamines are relevant to safety for the operation of CO₂ capture plants with amine-based solvents. Minimization of the nitrosamine concentration in the CO₂ capture operation is therefore of great importance for the public acceptance of the technology.

The formation of nitrosamines preferentially takes place under acidic conditions (pH<7). Nevertheless, nitrosamines are also formed under strongly alkaline conditions. As a result, a high concentration of nitrosamines accumulates in the CO₂ capture operation with time. A particular property of nitrosamines is the low thermal stability thereof, which is exploited, for example, in analysis methods, and it is not the nitrosamines themselves but their typical decomposition products that are detected under strong heating. However, a thermal treatment of the solvent to destroy the nitrosamines is impossible since the scrubbing-active amines are likewise not thermally stable in the solvents used and would likewise be destroyed by a thermal treatment. This should, however, be absolutely avoided.

Even in the case of distillative purification of amine-based solvents or solvent products for removal of degradation products, nitrosamines present difficulties. The distillation generally takes place at temperatures below 150°. This involves vaporizing the volatile amines in a vaporizer, and removing the troublesome residues as vaporization residues. Due to the relatively high molecular weight of the nitrosamines, depending on the respective vapor pressure thereof in the vaporization residue, however, a portion of the nitrosamines always remains, since nitrosamines exhibit a lower vapor pressure than the corresponding amines. The vaporization residue therefore contains a significant proportion of nitrosamines and has to be disposed of in a costly manner. Nitrosamines likewise remain in the purified solvent.

In the case of use of amino acid salts as an active wash substance in a solvent, the route of vaporization to eliminate the degradation products in the solvent is impossible since amino acid salts do not exhibit a significant vapor pressure. Here, however, regeneration of the solvent by crystallization is possible. However, the nitrosamines also have an adverse effect on the regeneration process and additionally contaminate the waste products, which therefore have to be disposed of in a costly manner as special waste. Although the emissions of the nitrosamines via the cleaned flue gas is ruled out in the case of use of amino acid salts, a reduction in the level of nitrosamines to a minimum degree would be highly advantageous.

To date, there are no known processes either in process technology or in power plant or CO₂ capture technology by which nitrosamines can be removed from solvents or solvent products without destroying the active amino acids in the solvent, or obtaining nitrosamine-containing residues or waste products.

### SUMMARY OF INVENTION

It is therefore an object of the invention to specify a process by which nitrosamines can be removed efficiently from a product, especially a solvent comprising an amine-based active substance without destroying the amines, and without requiring a costly disposal of the degradation products. In addition, the disadvantages from the prior art should be avoided. It is also an object of the invention to specify an apparatus in which the process according to the invention can be executed.

This object of the invention directed to a process is achieved by the features of the claims.

Accordingly, in the process for purifying a nitrosamine-contaminated product from an operating plant, the contaminated product is heated to a temperature T at which the nitrosamines are thermally destroyed. This temperature T is higher than the maximum temperature in the operating plant, and is maintained for a residence time t.

The invention utilizes the low thermal stability of nitrosamines, such that the nitrosamines are destroyed by heating. This is not obvious at first even to the person skilled in the art. This is because there is already damage to the active amino acid required for the CO₂ scrubbing at the temperatures from which thermal decomposition of nitrosamines sets in effectively.

In order not to damage the amino acid, a temperature is selected in accordance with the invention at which there is thermal destruction of the nitrosamines, but the amino acid remains substantially undamaged as the active substance. This temperature can, however, be comparatively low, such that the contaminated solvent has to be kept for a residence time appropriate to the temperature in order to very substantially destroy the nitrosamines. The level of the temperature, and the associated residence time t required, depend on factors including the amine dissolved in the solvent. Suitable amines are, for example, alkanolamines, amino acids or amino acid salts.

The core of the invention is thus, more particularly, the finding that the thermal destruction of nitrosamines is useable for the purification of a solvent contaminated with nitrosamines. A favorable selection of temperature T and residence time t makes it possible to establish an optimal ratio of degradation of the nitrosamines and the preservation of the amines.

By virtue of the invention, the nitrosamines are destroyed in the operation, such that minimization of the nitrosamines discharged by the flue gas is achieved. Since complex disposal of the nitrosamines is avoided, it is possible to operate an operating plant in which the nitrosamines are destroyed according to the teaching of the invention without a costly disposal of the solvents or waste products contaminated with nitrosamines. All in all, the invention reduces the cost and inconvenience for special measures to handle the nitrosamine-containing solvent.

The thermal decomposition takes place particularly effectively at a temperature T between 120° C. and 360° C. The level of the temperature T depends on the amino acid used. Depending on the temperature T, the residence time t is advantageously selected between 2 and 1600 minutes, though longer residence times are of course also possible. The thermal treatment preferably takes place in a closed vessel and under elevated pressure.

In an advantageous development of the process, an alkali is supplied to the product contaminated with nitrosamines before the purification, such that the pH of the contaminated product is adjusted to between 8 and 14. This development proceeds from the finding that some amino acids are particularly stable to heating with rising pH. It is thus possible to increase the temperature T and reduce the residence time t, which leads to an acceleration of the process. Potassium hydroxide KOH is a particularly advantageous option for raising the pH as a particularly strong alkali. This is because the CO₂ capture operation must also remove, inter alia, SOₓ in the form of K₂SO₄. As a result, the operation would continuously become deficient in potassium. An addition of potassium hydroxide KOH to the degree with which potassium is removed with the K₂SO₄ can firstly maintain the concentration of potassium, and additionally increase the pH.

The fact that some amino acids are particularly stable to heating with rising pH means, conversely, that the product which has been contaminated with nitrosamines and is employed for the process is preferably withdrawn at a point in the operating plant at which it has a relatively high pH. Therefore, preference is given to using a product for the process which is free of acids and especially has been substantially freed of carbon dioxide.

In an advantageous application of the process, the contaminated product is a solvent which is taken from a CO₂ capture operation in a fossil-fired power plant, the contaminated solvent containing at least the concentration of nitrosamine which is formed in the CO₂ capture operation. The process preferably takes place in parallel to the CO₂ capture operation. Accordingly, a permanent solvent stream is branched off from the CO₂ capture operation and purified by the process.

Alternatively, the process can also be used in the reprocessing of a waste product. The contaminated product in that case is a waste product contaminated with nitrosamines, which is formed, for example, in the reprocessing (reclaiming) of a solvent contaminated with nitrogen oxides NOₓ and/or sulfur oxides SOₓ from a CO₂ capture operation. The waste product is often concentrated or even saturated with nitrosamines. The process can also be used in other reprocessing processes for destruction of the nitrosamines. After sufficient residence time, the substantially nitrosamine-free waste product is cooled and can be disposed of conventionally. Thermal treatment of waste products additionally makes the handling thereof much simpler.

In another advantageous application, the process can also be operated in such a way that the contaminated product is taken and processed batchwise. As a result, the purifying operation is controlled separately from the CO₂ capture operation. This is advantageous particularly when the purification and the CO₂ capture operation do not take place at the same site. Batchwise processing is also advantageous when the purifying operation is performed within a time range in which the fossil-fired power plant has to provide an output of less than the nominal output. This is the case, for example, overnight, when lower output is required from the power plant and hence unutilized output reserves are available. The output which is not now required can be used for the purifying operation.

The use of amino acid salts as the active scrubbing substance in aqueous solution as a solvent has been found to be particularly advantageous. Amino acid salts do not have any detectable vapor pressure and are therefore advantageously suitable for the flue gas scrubbing.

The object of the invention directed to an apparatus is achieved by the features of the claims.

The apparatus for regenerating a nitrosamine-contaminated product from a carbon dioxide separation apparatus comprise an absorber and a desorber, as used in current CO₂ capture plants. Absorber and desorber are connected to one another by a line for a laden solvent and a line for a regenerated solvent. The lines form a solvent circuit between absorber and desorber. According to the invention, a thermal reactor now connected to one of the lines of the solvent circuit is one in which the process according to claim 1 can be executed. The thermal reactor is preferably a pressure vessel in which temperatures of between 120° C. and 360° C. can be established.

The thermal reactor is preferably connected to the line for a regenerated solvent, such that it is possible to supply a solvent substantially free of carbon dioxide to the thermal reactor. The line for a regenerated solvent leaves the desorber at the lower end, i.e. at the bottom of the desorber. Preferably, merely a sidestream is withdrawn from the regenerated solvent. As a result, the CO₂ capture plant is not influenced too significantly.

In an advantageous configuration of the carbon dioxide separation apparatus, the thermal reactor has a steam feedline, such that steam can be supplied from a steam generator operation of a steam power plant to heat the thermal reactor. Thus, the thermal reactor can also be integrated into a power plant.

The thermal reactor additionally ideally also has a supply line through which an alkali can be supplied to the thermal reactor.

On the output side, the thermal reactor is particularly advantageously connected to the desorber, such that a solvent purified to remove nitrosamines can be supplied to the desorber. This allows the thermal energy present after the thermal treatment of the nitrosamines to be released in the desorber, and also a contribution to be made to the stripping.

### BRIEF DESCRIPTION OF DRAWINGS

Working examples of the invention are explained in detail hereinafter with reference to figures. The figures show:

FIG. 1 shows an operating circuit diagram of a process for purifying a nitrosamine-contaminated product with an operating plant,

FIG. 2 a diagram showing typical degradation rates of nitrosamines and amino acids,

FIG. 3 a CO₂ capture plant with a connective thermal reactor,

FIG. 4 a reaction equation showing illustrative formation of a stable nitrosamine compound,

FIG. 5 a reaction equation showing illustrative thermal treatment of a stable nitrosamine compound.

### DETAILED DESCRIPTION OF INVENTION

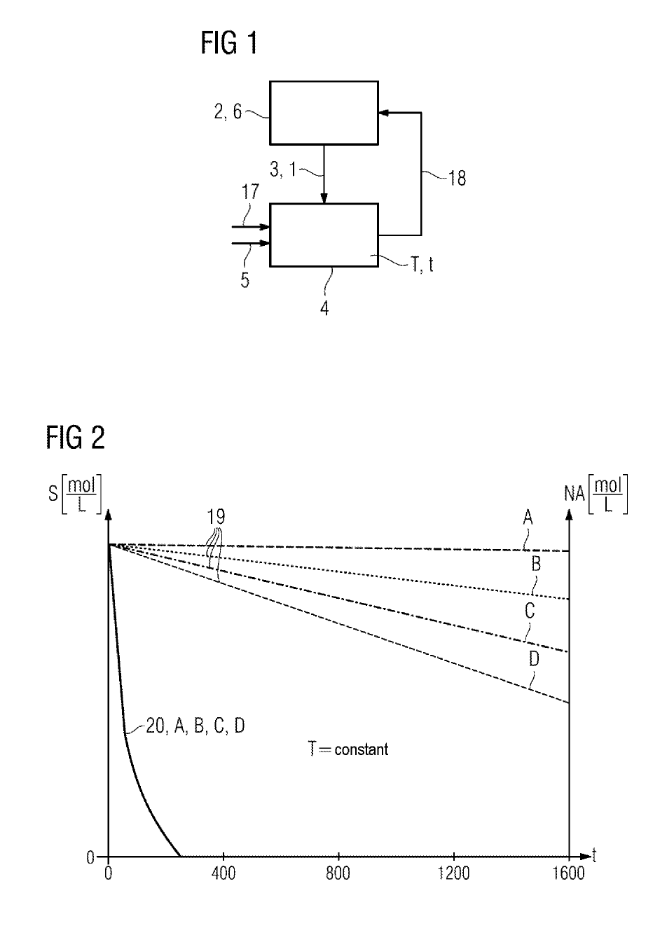

FIG. 1 shows a process 4 for purifying a product 1 contaminated with nitrosamines with an operating plant 2 shown as an operating circuit diagram. From the operating plant 2, which may, for example, be a CO₂ capture operation 6, a product 1 contaminated with nitrosamines is discharged and supplied to the process 4 for purification. The product is, for example, a scrubbing agent for wet-chemical scrubbing of carbon dioxide from a CO₂ capture operation 6, which is preferably a solvent with an amino acid as the active scrubbing substance.

In the process 4, the nitrosamines present in the contaminated product 1 are thermally destroyed. The reaction products of the thermal treatment are harmless to the health of organisms. In order to heat the contaminated product 1, the process 4 envisages the supply of a heat flow 17. This heats the contaminated product 1 to a temperature T which is higher than the temperature to which the contaminated product is exposed in the operating plant.

It has been found that effective destruction of nitrosamines sets in even at a temperature from 120° C. With rising temperature, this operation is accelerated. Since the amino acids present in the contaminated product 1, however, are also only of limited thermal stability, the temperature T cannot be selected freely. Depending on the amino acid used, it is therefore necessary to select a temperature T at which there is still no damage to the amino acid, but which is sufficient to bring about effective destruction of the nitrosamines.

It has been found to be particularly effective to use amino acid salt as the active scrubbing substance since it is particularly stable to heating at a high pH. In order to raise the pH, the process envisages the supply of an alkali 5. Even at a pH of 8 or higher, a significant rise in thermal stability is detectable. In the process 1, addition of the alkali 8 preferably establishes a very high pH of between 11 and 14. At this pH, in the case of use of an amino acid salt-based solvent, temperatures T of between 200 and 300° C. can be established without damaging the amino acid salt.

The temperature T to which the contaminated product is heated is maintained for a residence time t. This residence time t corresponds to the time after which the impurities, i.e. the nitrosamines, have been substantially thermally destroyed. The now purified product 18 can, as shown in FIG. 1, be recycled back into the operating plant. Not shown is the alternative disposal or further use in some other way.

FIG. 2 shows typical degradation rates of nitrosamines 20 and amino acid salt 19 at different pH in a schematic diagram. On the left-hand ordinate is plotted the amount of amino acid S in moles per liter of solvent. The right-hand ordinate shows the amount of nitrosamines NA, likewise in moles per liter. Plotted on the abscissa is the residence time t. The behavior of a solvent contaminated with nitrosamines with amino acid salt as the active additive was studied here. The solvent was studied at different pH concentrations. Curves A to D show the degradation rates at different pH. Curve A corresponds to a pH of greater than 12, curve B to a pH of 11, C to a pH of 10 and D to a pH of 9.

FIG. 2 shows that the degradation rates of nitrosamines 20 are virtually the same at the different pH values A, B, C and D. In contrast, the degradation rates of amino acid salt 19 are dependent on the pH. It is evident that the degradation rate rises with falling pH. The degradation rate of amino acid salt 19 at a pH of greater than 12 (curve A) shows virtually zero degradation rate. The amino acid salt 19 is substantially preserved as a scrubbing-active substance in the solvent. At a pH of 11 (curve B), there is already detectable degradation of the amino acid salt 19, which already damages the solvent to a significant degree with increasing residence time t. The damage to the amino acid salt 19 is even greater with a corresponding residence time t at an even lower pH. For instance, curve C (pH 10) and curve D (pH 9) already show considerable damage to the solvent as a result of the degradation of the amino acid salt 19.

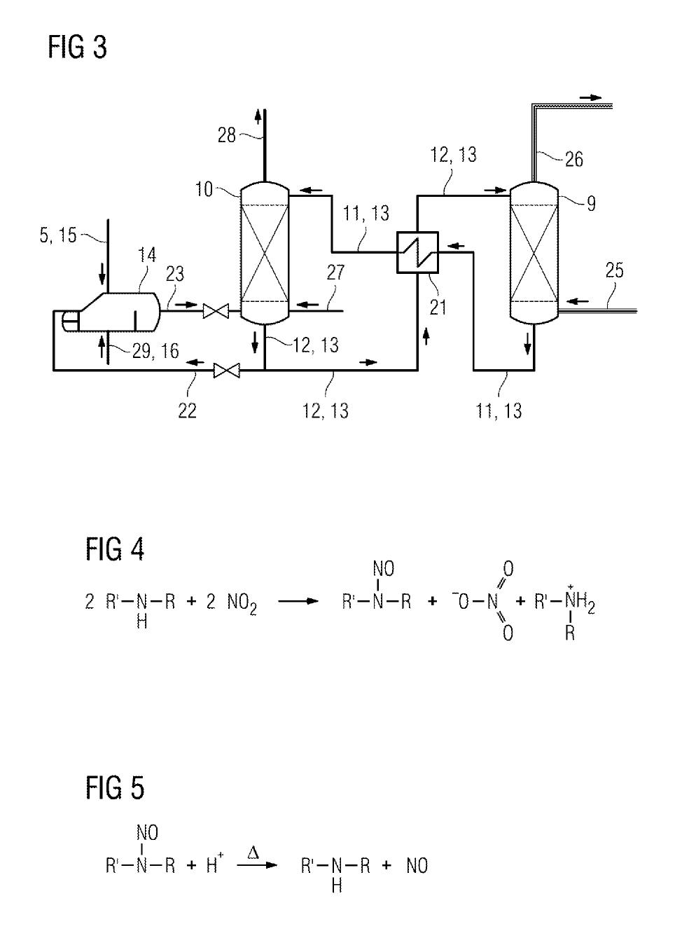

FIG. 3 shows a CO₂ capture plant 8 with a connective thermal reactor 14. The CO₂ capture plant 8 consists essentially of an absorber 9 and a desorber 10, and a line 11 for a laden solvent and a line 12 for a regenerated solvent, which together form a solvent circuit 13 for a solvent. The solvent circuit includes a crossflow heat exchanger 21, by which heat can be transferred from the regenerated solvent to the laden solvent 11. Not shown here are further heat exchangers for heating or cooling the solvent stream, which are also appropriately used at different sites in the solvent circuit 13. There has likewise been no attempt to show additional components irrelevant to the illustration of the invention, such as pumps, measurement sensors or control and regulating devices.

A CO₂-containing flue gas 25 is supplied to the absorber in the lower region, which originates, for example, from a fossil-fired power plant. Such flue gases 25 contain, as well as CO₂, also compounds such as N₂, O₂, SOₓ and NOₓ, which are also introduced into the CO₂ capture plant 8. In the upper region of the absorber 9, a flue gas 26 essentially freed of CO₂ is discharged, which also comprises N₂ and O₂ as well as other flue gas components.

In the absorber 9, CO₂ is scrubbed out wet-chemically by a solvent. To increase the capacity of the solvent, an amine (amino acid or amino acid salt) is dissolved in the solvent. The amines in the solvent form nitrosamines together with the NOₓ from the flue gas. Via line 11, the laden solvent contaminated with nitrosamines is passed into the upper region of the desorber 10. In the desorber 10, the solvent is stripped, or the CO₂ is boiled, out of the solvent with supply of heat 27, for example in the form of steam. At the top of the desorber 10, a vapor is discharged, which consists of gaseous CO₂ and vaporized steam. In the lower region, the solvent which has now been substantially freed of CO₂ but is still contaminated with nitrosamines is discharged via line 12.

Connected to line 12 via a supply line 22 is the thermal reactor 14. Heat energy 29 can be supplied to the thermal reactor 14 via a steam supply line 16. An alkali 5 can be supplied to the thermal reactor 14 via a line 15. As a result of the heating of the solvent at a set temperature T for a residence time t, the nitrosamines in the solvent are substantially thermally destroyed and decomposed to products harmless to the organism. Through a removal line 23 which connects the thermal reactor to the desorber 10, a regenerated solvent which has been substantially freed of nitrosamine impurities can be recycled to the desorber. The recycling of the solvent treated in the thermal reactor 14 into the desorber 10 allows the heat to be recovered from the superheated solvent for the desorption. Alternatively, the thermal reactor 14 can also be connected within or in parallel to line 12.

A regulating valve 24 which may be inserted into each of the supply line 22 and the removal line 23 can decouple the thermal reactor 14 from the solvent circuit 13. This enables batchwise processing of the solvent.

FIG. 4 shows a reaction equation showing illustrative formation of a stable nitrosamine compound from a secondary amine and nitrogen dioxide. The amine may be an alkanolamine, an amino acid or an amino acid salt. The nitrosamine compound formed is stable under the conditions of the CO₂ capture operation. R may be an aryl or alkyl radical. R′ may be an aryl, alkyl, or a deprotonated acid with an appropriate cation.

FIG. 5 shows, in a reaction equation, the inventive thermal treatment of a stable nitrosamine compound. The stable nitrosamine compound formed from a secondary amino acid decomposes as a result of the supply of heat to products harmless to the human organism.

1.-15. (canceled)

16. A process for purifying a solvent contaminated with nitrosamine as a product from a CO₂ capture plant, comprising:
heating the contaminated product to a temperature T at which the nitrosamine is thermally destroyed, the temperature T being higher than maximum temperature in the CO₂ capture plant; and
maintaining the temperature T for a residence time t,
wherein the solvent is taken from a CO₂ capture operation in a fossil-fired power plant, and,
wherein the contaminated product contains at least concentration of the nitrosamine which is formed in the CO₂ capture operation.

17. The process as claimed in claim 16, wherein the temperature T is set between 120° C. and 360° C.

18. The process as claimed in claim 16, wherein the residence time t is set between 2 and 1600 minutes.

19. The process as claimed in claim 16, wherein an alkali is supplied to the contaminated product before the purification such that pH of the contaminated solvent is adjusted to between 8 and 14.

20. The process as claimed in claim 19, wherein the supplied alkali is potassium hydroxide KOH.

21. The process as claimed in claim 16, wherein the contaminated product has been substantially freed of carbon dioxide.

22. The process as claimed in claim 16, wherein the contaminated product is a nitrosamine-contaminated waste product which is formed in the reprocessing of a solvent contaminated with nitrogen oxides NOx and/or with sulfur oxides SOx from the CO₂ capture operation.

23. The process as claimed in claim 16, wherein the contaminated product is taken batchwise from the CO₂ capture operation and processed.

24. The process as claimed in claim 23, wherein the batchwise processing is performed within a time range in which the fossil-fired power plant has to provide an output of less than nominal output.

25. The process as claimed in claim 16, wherein the solvent is an aqueous solution and contains an amino acid salt.

26. An apparatus for regeneration of a nitrosamine-contaminated product from a CO₂ capture plant, comprising:
an absorber and a desorber being connected to one another by a line for a laden solvent and a line for a regenerated solvent in such a way that a solvent circuit is formed between the absorber and the desorber; and
a thermal reactor being connected to a line in the solvent circuit,
wherein a process is executed in the thermal reactor for heating the contaminated product to a temperature T at which the nitrosamine is thermally destroyed and maintaining the temperature T for a residence time t, and
wherein the temperature T is higher than maximum temperature in the CO₂ capture plant.

27. The apparatus as claimed in claim 26, wherein the thermal reactor is connected to the line for a regenerated solvent such that a solvent is supplied substantially free of carbon dioxide to the thermal reactor.

28. The apparatus as claimed in claim 26, wherein steam from a steam power plant can be supplied to the thermal reactor via a steam supply line.

29. The apparatus as claimed in claim 26, wherein the thermal reactor comprises a supply line for an alkali.

30. The apparatus as claimed in claim 26, wherein the thermal reactor is connected to the desorber by an output such that a solvent purified to remove the nitrosamine can be supplied to the desorber.
